(19) United States
(12) Patent Application Publication
(10) Pub. No.: US 2011/0134495 A1
(43) Pub. Date: Jun. 9, 2011

(54) ERECTING EQUAL-MAGNIFICATION LENS ARRAY PLATE, OPTICAL SCANNING UNIT, AND IMAGE READING DEVICE

(75) Inventor: Hideshi NAGATA, Minato-ku (JP)

(73) Assignee: NIPPON SHEET GLASS COMPANY, LIMITED, Tokyo (JP)

(21) Appl. No.: 12/958,903

(22) Filed: Dec. 2, 2010

(30) Foreign Application Priority Data
Dec. 3, 2009 (JP) 2009-275344

(51) Int. Cl. H04N 1/04; G02B 27/12

(52) U.S. Cl. 358/474; 359/622

(57) ABSTRACT

An erecting equal-magnification lens array plate includes: a first lens array plate provided with a plurality of first lenses and a plurality of second lenses; a second lens array plate provided with a plurality of third lenses and a plurality of fourth lenses; a first light-shielding wall having a plurality of first through holes; and a second light-shielding wall having a plurality of second through holes. The first through hole and the second through hole each includes: a lateral wall portion; an annular inner projection portion provided to project from an end of the lateral wall portion; and an annular outer projection portion provided to project from an end of the lateral wall portion facing the lens. The inner projection portion and the outer projection portion are not formed with a surface parallel to an optical axis.

### BACKGROUND OF THE INVENTION

1. Field of the Invention

The present invention relates to erecting equal-magnification lens array plates used in image reading devices and image forming devices and to optical scanning units and image reading devices using the erecting equal-magnification lens array plate.

2. Description of the Related Art

Some image reading devices such as scanners are known to use erecting equal-magnification optics. Erecting equal-magnification optics are capable of reducing the size of devices better than reduction optics. In the case of image reading devices, an erecting equal-magnification optical system comprises a line light source, an erecting equal-magnification lens array, and a line image sensor.

A rod lens array capable of forming an erect equal-magnification image is used as an erecting equal-magnification lens array in an erecting equal-magnification optical system. Normally, a rod lens array comprises an arrangement of rod lenses in the longitudinal direction (main scanning direction of the image reading device) of the lens array. By increasing the number of columns of rod lenses, the proportion of light transmitted is improved and unevenness in the amount of light transmitted is reduced. Due to price concerns, it is common to use one or two columns of rod lenses in a rod lens array.

Meanwhile, an erecting equal-magnification lens array plate could be formed as a stack of a plurality of transparent lens array plates built such that the optical axes of individual convex lenses are aligned, where each transparent lens array plate includes a systematic arrangement of micro-convex lenses on one or both surfaces of the plate. Since an erecting equal-magnification lens array plate such as this can be formed by, for example, injection molding, erecting equal-magnification lens arrays in a plurality of columns can be manufactured at a relatively low cost.

An erecting equal-magnification lens array plate lacks a wall for beam separation between adjacent lenses. Therefore, there is a problem of stray light wherein a light beam diagonally incident on an erecting equal-magnification lens array plate travels diagonally inside the plate and enters an adjacent convex lens, creating noise (also referred to as ghost as it leaves the plate).

There is known an erecting equal-magnification lens array plate in which a light shielding wall for removing stray light not contributing to imaging is formed on the surface of the plate (see, for example, patent document No. 1).

[patent document No. 1] JP2009-069801

However, when a light shielding wall is provided on the surface of the erecting equal-magnification lens array plate, light reflected by the light shielding wall may produce flare noise.

### SUMMARY OF THE INVENTION

The present invention addresses the background and a purpose thereof is to provide an erecting equal-magnification lens array plate capable of reducing flare noise, an optical scanning unit and an image reading device using such a plate.

The erecting equal-magnification lens array plate that addresses the above-described disadvantage comprises: a first lens array plate provided with a plurality of first lenses systematically arranged on a first surface and a plurality of second lenses systematically arranged on a second surface opposite to the first surface; a second lens array plate provided with a plurality of third lenses systematically arranged on a third surface and a plurality of fourth lenses systematically arranged on a fourth surface opposite to the third surface; a first light-shielding wall having a plurality of first through holes aligned with the first lenses, and provided on the first surface such that each of the first through holes is located opposite to the corresponding first lens; and a second light-shielding wall having a plurality of second through holes aligned with the fourth lenses, and provided on the fourth surface such that each of the second through holes is located opposite to the corresponding fourth lens. The first lens array plate and the second lens array plate form a stack such that the second surface and the third surface face each other to ensure that a combination of the lenses aligned with each other form a coaxial lens system, the erecting equal-magnification lens array plate receiving light from a line light source facing the first surface and forming an erect equal-magnification image of the line light source on an image plane facing the fourth surface. Each of the first through holes or each of the second through holes, or each of the first and second through holes, comprises: a lateral wall portion; an annular inner projection portion provided to project from an end of the lateral wall portion facing the lens; and an annular outer projection portion provided to project from an end of the lateral wall portion opposite to the end facing the lens, wherein the inner projection portion and the outer projection portion are not formed with a surface parallel to an optical axis.

According to this embodiment, the inner projection portion and the outer projection portion shield light causing flare noise so that flare noise is reduced.

The outer projection portion may be formed with a surface inclined at 45° or greater with respect to the optical axis. The inner projection portion may be formed with a surface inclined by an angle equal to or greater than half a corrected effective angle of view with respect to the optical axis. In these cases, flare noise caused by the light reflected by the inner projection portion and the outer projection portion is suitably reduced.

The inner projection portion and the outer projection portion may be formed such that the portions have the identical height. In this case, flare noise is suitably reduced and the light incident on the lens is ensured to be brightest.

The erecting equal-magnification lens array plate may be configured such that

tan X=0.5×OD/(h−sag(ID)) and

(MD−(D+ID)×0.5)/h≧tan Y′,

where X denotes a light-shielding wall angle of view, Y′ denotes a corrected effective angle of view, MD denotes an inner diameter of the lateral wall portion, OD denotes a diameter of an opening formed inside the outer projection portion, ID denotes a diameter of an opening formed inside the inner projection portion, sag denotes a lens height determined by ID and a lens shape. In this case, flare noise is suitably reduced.

The erecting equal-magnification lens array plate may further comprises an intermediate light-shielding member having a plurality of third through holes aligned with the second lenses and the third lenses, wherein the intermediate light-shielding member is provided between the first lens array plate and the second lens array plate such that the third through holes are located opposite to the corresponding second lenses and the corresponding third lenses. In this case, flare noise is suitably reduced.

The erecting equal-magnification lens array plate may be configured such that

tan X=0.5×OD/(h−sag(ID)) and

(MD−(OD+ID)×0.5)/h≧tan Y′×0.78,

where X denotes a light-shielding wall angle of view, Y′ denotes a corrected effective angle of view, MD denotes an inner diameter of the lateral wall portion, OD denotes a diameter of an opening formed inside the outer projection portion, ID denotes a diameter of an opening formed inside the inner projection portion, sag denotes a lens height determined by ID and a lens shape.
In this case, too, flare noise is suitably reduced.

Another embodiment of the present invention also relates to an erecting equal-magnification lens array plate. The erecting equal-magnification lens array plate comprises: a first lens array plate provided with a plurality of first lenses systematically arranged on a first surface and a plurality of second lenses systematically arranged on a second surface opposite to the first surface; a second lens array plate provided with a plurality of third lenses systematically arranged on a third surface and a plurality of fourth lenses systematically arranged on a fourth surface opposite to the third surface, a first light-shielding wall having a plurality of second through holes aligned with the first lenses, and provided on the first surface such that each of the first through holes is located opposite to the corresponding first lens; and a second light-shielding wall having a plurality of first through holes aligned with the fourth lenses, and provided on the fourth surface such that each of the second through holes is located opposite to the corresponding fourth lens. The first lens array plate and the second lens array plate form a stack such that the second surface and the third surface face each other to ensure that a combination of the lenses aligned with each other form a coaxial lens system, the erecting equal-magnification lens array plate receiving light from a line light source facing the first surface and forming an erect equal-magnification image of the line light source on an image plane facing the fourth surface. At least one of the first through hole and the second through hole comprises: a lateral wall portion; an annular inner projection portion provided to project from an end of the lateral wall portion facing the lens, or an annular outer projection portion provided to project from an end of the lateral wall portion opposite to the end facing the lens, wherein the inner projection portion and the outer projection portion are not formed with a surface parallel to an optical axis.

In this embodiment, too, the inner projection portion or the outer projection portion shield light causing flare noise so that flare noise is reduced.

Still another embodiment of the present invention relates to an optical scanning unit. The optical scanning unit comprises: a line light source configured to illuminate an image to be read; the erecting equal-magnification lens array plate described above configured to condense light reflected by the image to be read; and a line image sensor configured to receive light transmitted by the erecting equal-magnification lens array plate.

According to the embodiment, the optical scanning unit comprises the aforementioned erecting equal-magnification lens array plate. Therefore, the line image sensor can receive an erect equal-magnification image in which flare noise is reduced.

Yet another embodiment of the present invention relates to an image reading device. The device comprises: the optical scanning unit; and an image processing unit configured to process an image signal detected by the optical scanning unit.

According to this embodiment, high-quality image data in which flare noise is suitably reduced can be generated since the image reading device is formed using the optical scanning unit.

Optional combinations of the aforementioned constituting elements, and implementations of the invention in the form of methods, apparatuses, and systems may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows an image reading device according to an embodiment of the present invention;

FIG. 2 shows a partial section of the optical scanning unit in the main scanning direction;

FIG. 3 is a partial top view of the erecting equal-magnification lens array plate viewed from a document;

FIG. 4 shows the operation of an erecting equal-magnification lens array plate according to a comparative example;

FIG. 5 shows the operation of the erecting equal-magnification lens array plate according to the embodiment;

FIG. 6 is an explanatory diagram of a light-shielding wall angle of view;

FIG. 7 is a partial enlarged view of the erecting equal-magnification lens array plate;

FIG. 8 shows that the primary beam is asymmetrical;

FIG. 9 is an explanatory diagram of an effective angle of view;

FIG. 10 is an explanatory diagram showing how flare noise is caused;

FIG. 11 is an explanatory diagram showing how the angle of incidence that allows beams to be shielded without providing the inner projection portion and the outer projection portion is determined;

FIG. 12 is an explanatory diagram showing a condition that defines the outer opening diameter;

FIGS. 13A-13D are explanatory diagrams showing conditions that define the outer diameter in the case that the inner opening diameter the outer opening diameter;

FIG. 14 is an explanatory diagram showing an angle of inclination of the tapered surface formed in the outer projection portion;

FIG. 15 is an explanatory diagram showing an angle of inclination of the tapered surface formed in the inner projection portion;

FIG. 16 is an explanatory diagram showing an erecting equal-magnification lens array plate according to another embodiment of the present invention;

FIG. 17 shows how the noise ratio varies as the structure of the erecting equal-magnification lens array plate is varied;

FIG. 18 shows variation in the amount of noise correlated with the variation in (MD−OD)/h;

FIG. 19 shows the relation between (MD−OD)/h and the noise ratio;

FIG. 20 shows a variation of the outer projection portion;

FIG. 21 shows variations of the inner projection portion and the outer projection portion;

FIG. 22 is an explanatory diagram showing an erecting equal-magnification lens array plate according to still another embodiment of the present invention;

FIG. 23 is an explanatory diagram showing the angle of inclination φ of the inverse tapered surface of the first light-shielding wall with respect to the optical axis;

FIG. 24 is an explanatory diagram showing an erecting equal-magnification lens array plate according to still another embodiment of the present invention;

FIG. 25 is an explanatory diagram showing an erecting equal-magnification lens array plate according to still another embodiment of the present invention; and

FIG. 26 is an explanatory diagram showing an erecting equal-magnification lens array plate according to still another embodiment of the present invention.

### DETAILED DESCRIPTION OF THE INVENTION

The invention will now be described by reference to the preferred embodiments. This does not intend to limit the scope of the present invention, but to exemplify the invention.

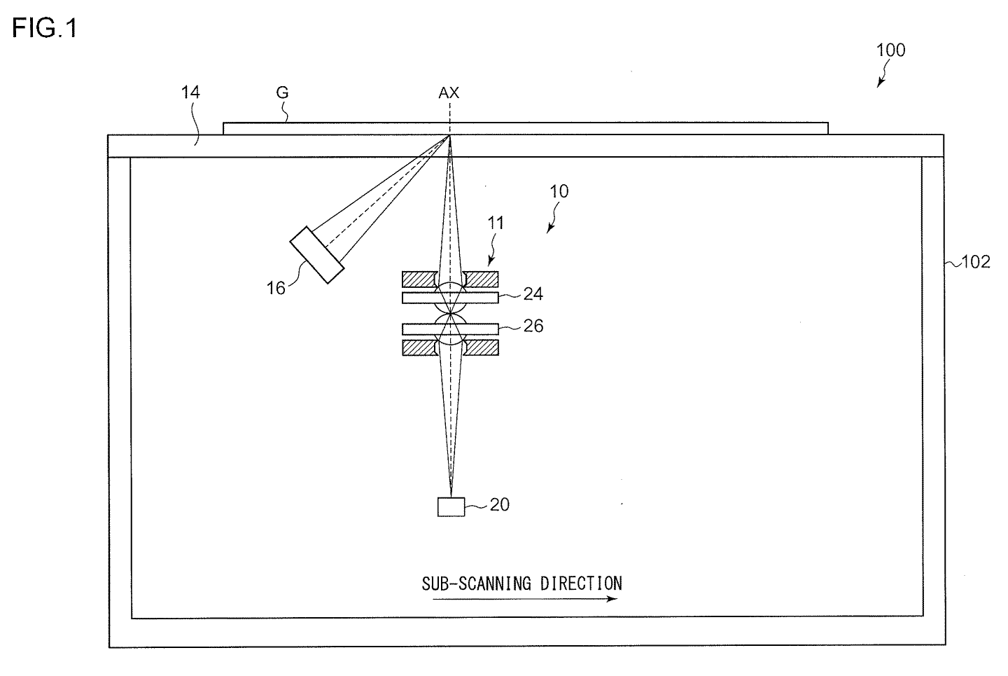

FIG. 1 shows an image reading device 100 according to an embodiment of the present invention. As shown in FIG. 1, the image reading device 100 comprises a housing 102, a glass plate 14 on which a document G is placed, an optical scanning unit 10 accommodated in the housing 102, a driving mechanism (not shown) for driving the optical scanning unit 10, and an image processing unit (not shown) for processing data read by the optical scanning unit 10.

The optical scanning unit 10 comprises a line light source 16 for illuminating a document G placed on a glass plate 14, an erecting equal-magnification lens array plate 11 for condensing light reflected from the document G, a line image sensor (photoelectric transducer) 20 for receiving light condensed by the erecting equal-magnification lens array plate 11, and a housing (not shown) for fixing the line light source 16, the erecting equal-magnification lens array plate 11, and the line image sensor 20.

The line light source 16 is a light source emitting a substantially straight light. The line light source 16 is secured such that the optical axis of the illuminating light passes through the intersection of the optical axis Ax of the erecting equal-magnification lens array plate 11 and the top surface of the glass plate 14. The light exiting the line light source 16 illuminates the document G placed on the glass plate 14. The light illuminating the document G is reflected by the document G toward the erecting equal-magnification lens array plate 11.

The erecting equal-magnification lens array plate 11 comprises a stack of a first lens array plate 24 and a second lens array plate 26 built such that pairs of corresponding lenses form a coaxial lens system, where each lens array plate is formed with a plurality of convex lenses on both surfaces of the plate, as described later. The first lens array plate 24 and the second lens array plate 26 are held by a holder (not shown) in a stacked state. The erecting equal-magnification lens array plate 11 is installed in the image reading device 100 such that the longitudinal direction thereof is aligned with the main scanning direction and the lateral direction thereof is aligned with the sub-scanning direction.

The erecting equal-magnification lens array plate 11 is configured to receive line light reflected from the document G located above and form an erect equal-magnification image on an image plane located below, i.e., a light-receiving surface of the line image sensor 20. The image reading device 100 can read the document G by scanning document G with the optical scanning unit 10 in the sub-scanning direction.

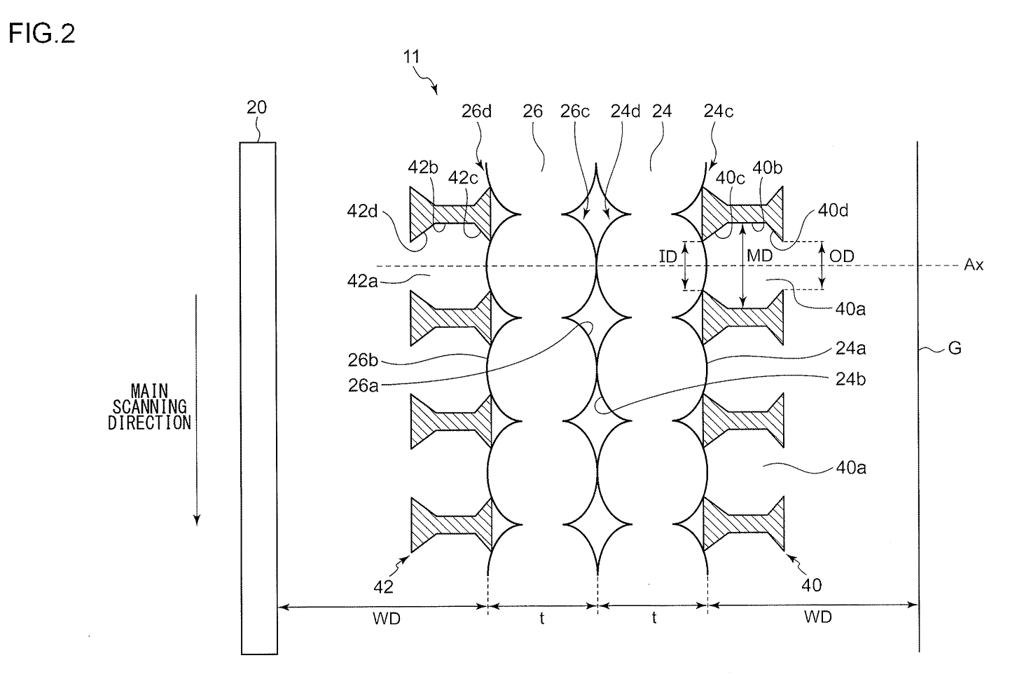

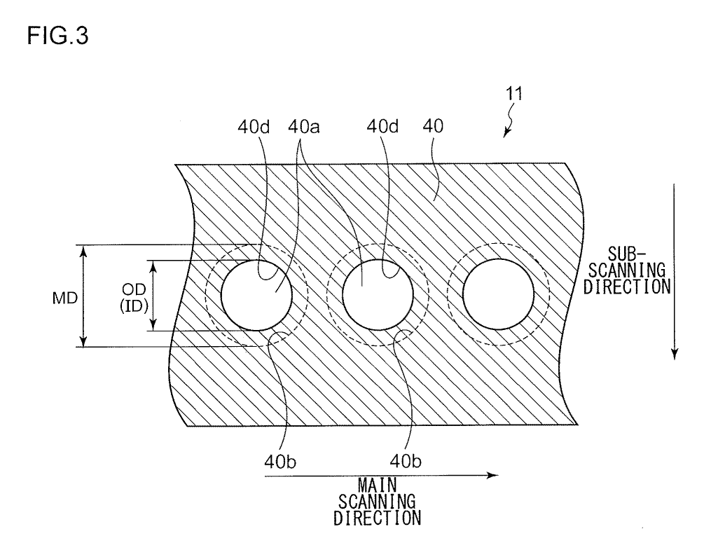

A description will now be given, with reference to FIGS. 2 and 3, of the erecting equal-magnification lens array plate 11 according to the embodiment. FIG. 2 shows a partial section of the optical scanning unit in the main scanning direction. Referring to FIG. 2, the vertical direction in the illustration represents main scanning direction (longitudinal direction) of the erecting equal-magnification lens array plate 11 and the depth direction in the illustration represents the sub-scanning direction (lateral direction). FIG. 3 is a top view of a part of the erecting equal-magnification lens array plate 11 viewed from the document G. Referring to FIG. 3, the horizontal direction in the illustration represents the main scanning direction (longitudinal direction) of the erecting equal-magnification lens array plate 11 and the vertical direction in the illustration represents the sub-scanning direction (lateral direction).

As described above, the erecting equal-magnification lens array plate 11 comprises a stack of the first lens array plate 24 and the second lens array plate 26. Each of the first lens array plate 24 and the second lens array plate 26 is a rectangular plate having a thickness t and is provided with an arrangement of a plurality of convex lenses on both sides thereof.

The first lens array plate 24 and the second lens array plate 26 are formed by injection molding. Preferably, each of the first lens array plate 24 and the second lens array plate 26 is formed of a material amenable to injection molding, having high light transmittance in a desired wavelength range, and having low water absorption. Desired materials include cycloolefin resins, olefin resins, norbornene resins, and polycarbonate.

A plurality of first lenses 24a are arranged in a single line on a first surface 24c (one of the surfaces of the first lens array plate 24) in the longitudinal direction of the first lens array plate 24. A plurality of second lenses 24b having a lens diameter D are arranged in a single line on a second surface 24d of the first lens array plate 24 opposite to the first surface 24c in the longitudinal direction of the first lens array plate 24.

A plurality of third lenses 26a are arranged in a single line on a third surface 26c (one of the surfaces of the second lens array plate 26) in the longitudinal direction of the second lens array plate 26. A plurality of fourth lenses 26b are arranged in a single line on a fourth surface 26d opposite to the third surface 26c in the longitudinal direction of the second lens array plate 26.

In this embodiment, it is assumed that the first lens 24a, the second lens 24b, the third lens 26a, and the fourth lens 26b are spherical in shape. Alternatively, the lenses may have aspherical shapes.

The first lens array plate 24 and the second lens array plate 26 form a stack such that the second surface 24d and the third surface 26c face each other to ensure that a combination of the first lens 24a, second lens 24b, third lens 26a, and fourth lens 26b aligned with each other form a coaxial lens system. While it is assumed in this embodiment that the second lens 24b on the second surface 24d and the third lens 26a on the third surface 26c are in contact with each other, the second lens 24b and the third lens 26a may be at a distance from each other.

In this embodiment, a first light shielding wall 40 is provided on the first surface 24c of the first lens array plate 24. The first light shielding wall 40 is a light-shielding member of a plate shape made of a light-shielding material and is formed with a plurality of first through holes 40a. The first through holes 40a are arranged in a single line in the longitudinal direction of the first light-shielding wall 40 so as to be alignment with the first lenses 24a of the first lens array plate 24. The first light-shielding wall 40 is provided on the first surface 24c of the first lens array plate 24 such that each first through hole 40a is located opposite to the corresponding first lens 24a. The first light shielding wall 40 functions to shield stray light from being incident on the first lens 24a.

As shown in FIGS. 2 and 3, each first through hole 40a of the first light-shielding wall 40 is provided with a cylindrical lateral wall portion 40b provided upright so as to surround a space above the first lens 24a, an annular inner projection portion 40c provided at the end of the lateral wall portion 40b facing the first lens 24a, and an outer projection portion 40d provided at the end of the lateral wall portion 40b facing the document G. The inner projection portion 40c and the outer projection 40d are provided so as to project from the inner circumferential edge of the lateral wall portion 40b toward the center of the hole.

As shown in FIGS. 2 and 3, an opening having an opening diameter ID (hereinafter, inner opening diameter ID) is formed inside the inner projection portion 40c, and an opening having an opening diameter OD (hereinafter, referred to as outer opening diameter OD) is formed inside the outer projection portion 40d. In this embodiment, the inner projection portion 40c and the outer projection portion 40d are formed such that the portions have the identical height. Therefore, given that the inner diameter of the lateral wall portion 40b is denoted by MD, the inner diameter ID=the outer opening diameter OD<the inner opening diameter MD. FIG. 2 shows that the inner projection portion 40c is in contact with the first lens 24a, they may be spaced apart.

The inner projection portion 40c and the outer projection portion 40d are formed such that there are no surfaces parallel to the optical axis Ax of the lens system. As shown in FIG. 2, the inner projection portion 40c according to this embodiment is tapered such that the inner diameter is progressively larger from the edge facing the first lens 24a toward the center of the first through hole 40a in the direction of height. The outer projection portion 40d is tapered such that the inner diameter is progressively larger from the end facing the document G toward the center of the first through hole 40a in the direction of height.

A second light shielding wall 42 is provided on the fourth surface 26d of the second lens array plate 26. The second light shielding wall 42 is also a light-shielding member of a plate shape made of a light-shielding material and is formed with a plurality of second through holes 42a. The second through holes 42a are arranged in a single line in the longitudinal direction of the second light-shielding wall 42 so as to be alignment with the fourth lenses 26b of the second lens array plate 26. The second light-shielding wall 42 is provided on the fourth surface 26d of the second lens array plate 26 such that each second through hole 42a is located opposite to the corresponding fourth lens 26b. The second light shielding wall 42 functions as a light shielding member for preventing stray light from exiting the fourth lens 26b.

As in the first light-shielding wall 40, each second through hole 42a of the second light-shielding wall 42 is provided with a cylindrical lateral wall portion 42b provided upright so as to surround a space above the fourth lens 26b, an annular inner projection portion 42c provided at the end of the lateral wall portion 42b facing the fourth lens 26b, and an outer projection portion 42d provided at the end of the lateral wall portion 42b facing the line image sensor 20. The inner projection portion 42c and the outer projection portion 42d are provided so as to project from the inner circumferential edge of the lateral wall portion 42b toward the center of the hole. The shapes of the lateral wall portion 42b, the inner projection portion 42c, and the outer projection portion 42d of the second through hole 42a are identical to those of the first through hole 40a so that a detailed description is omitted. FIG. 2 shows that the inner projection portion 42c is in contact with the fourth lens 26b, they may be spaced apart.

The first light shielding wall 40 and the second light shielding wall 42 may be formed by, for example, injection molding using a light absorbing material such as black ABS resin. The first light shielding wall 40 and the second light shielding wall 42 may be formed by coating the first surface 24c and the fourth surface 26d with a stack of black resin paint.

The erecting equal-magnification lens array plate 11 as configured above is built in the image reading device 100 such that the distance from the first lens 24a to the document G and the distance from the fourth lens 26b to the line image sensor 20 are equal to a predetermined working distance WD.

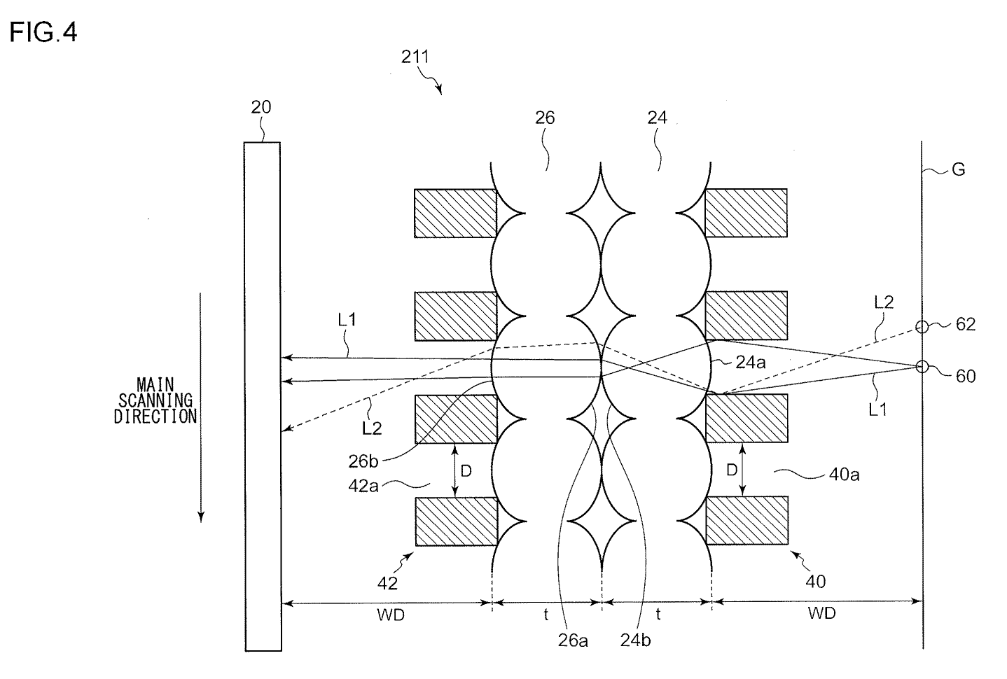

A description will now be given of the operation of the erecting equal-magnification lens array plate 11 according to the embodiment. Before describing the operation of the erecting equal-magnification lens array plate 11, a comparative example will be shown. FIG. 4 shows the operation of an erecting equal-magnification lens array plate 211 according to a comparative example. In the erecting equal-magnification lens array plate 211 according to the comparative example, the first through holes 40a of the first light-shielding wall 40 and the second through holes 42a of the second light-shielding wall 42 are simply cylindrically formed. Inner projection portions or outer projection portions are not formed. In other words, the inner diameter D of the first through holes 40a and the second through holes 42a in the erecting equal-magnification lens array plate 211 remains constant in the direction of height of the through holes.

First, a beam L1 (solid line) emitted from a point 60 on the document G located on the optical axis of the first lens 24a will be discussed. Normally, the beam L1 about to be incident on the first lens array plate 24 at an angle of incidence larger than the imaging light is absorbed by the lateral wall of the first through hole 40a of the first light shielding wall 40. However, the beam L1 is not completely absorbed even if a light absorbing material is used. The beam L1 is partly incident on the first lens 24a due to Fresnel reflection. This is because, the Fresnel reflectance for an angle of incidence as large as 90° of the beam L1 incident on the lateral wall of the first through hole 40a is extremely large.

As shown in FIG. 4, the reflected beam L1 is transmitted through the first lens 24a, the second lens 24b, the third lens 26a, and the fourth lens 26b before being incident on the line image sensor 20, causing flare noise. Hereinafter, the term “angle of incidence” is intended to mean an angle of incidence on the erecting equal-magnification lens array plate unless otherwise specified.

Secondly, a beam L2 (broken line) emitted from a point 62 on the document G outside the optical axis of the first lens 24a will be discussed. The beam L2 is partly reflected by the lateral wall of the first through hole 40a by Fresnel reflection. As shown in FIG. 4, the reflected beam L2 is transmitted through the first lens 24a, the second lens 24b, the third lens 26a, and the fourth lens 26b before being incident on the line image sensor 20, causing flare noise.

Flare noise caused by the reflection by the first light shielding wall 40 is described with reference to FIG. 4. Flare noise is also caused by the reflection by the second light shielding wall 42.

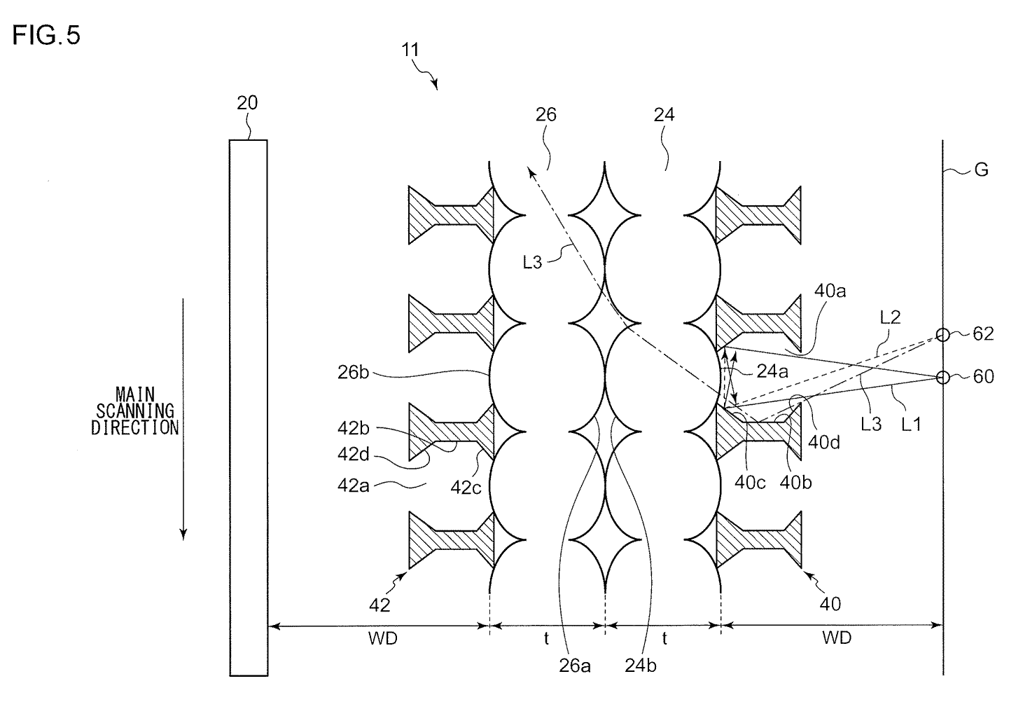

FIG. 5 shows the operation of the erecting equal-magnification lens array plate 11 according to the embodiment. First, as in the case of the comparative example of FIG. 4, the beam (solid line) emitted from the point 60 on the document G located on the optical axis of the first lens 24a will be discussed. In this embodiment, the beam L1 is incident on the inner projection portion 40c of the first through hole 40a. Since the interior surface of the inner projection portion 40c is formed as a tapered surface inclined with respect to the optical axis, the beam L1 reflected by the inner projection portion 40c is reflected multiple times in the first through hole 40a without being incident on the first lens 24a. Since the angle of incidence on the tapered surface of the inner projection portion 40c is comparatively smaller than the angle in the comparative example, the Fresnel reflection coefficient will be small so that the beam L1 is considerably attenuated. Therefore, the beam L1 does not reach the line image sensor 20 so that flare noise due to the beam L1 is not produced. The same discussion applies to the beam L2 (broken line) emitted from the point 62 outside the optical axis.

A beam L3 (chain line) having an angle of incidence larger than that of the beam L2 and incident on the lateral wall portion 40b of the first through hole 40a after being emitted from the point 62 on the document G will be discussed. The beam L3 does not impinge upon the inner projection portion 40c due to the large angle of incidence and is incident on the first lens 24a. However, since the beam L3 is greatly inclined with respect to the optical axis, the beam impinges upon the second light-shielding wall 42 and does not reach the line image sensor 20. Therefore, flare noise caused by the light L3 is not produced.

The action of reducing flare noise by the inner projection portion 40c of the first through hole 40a, etc. is described with reference to FIG. 5. Flare noise is similarly reduced by the inner projection portion 42c of the second through hole 42a, etc.

As described above, the erecting equal-magnification lens array plate 11 according to the embodiment is capable of reducing flare noise. The erecting equal-magnification lens array plate 11 is capable of removing stray light diagonally incident on the erecting equal-magnification lens array plate 11 and producing ghost, using the first light shielding wall 40 or the second light shielding wall 42. Accordingly, the erecting equal-magnification lens array plate according to this embodiment can form high-quality erect equal-magnification images with reduced noise.

A discussion will now be given of the size of the outer opening diameter OD necessary to suitably prevent flare noise. The terms “light-shielding wall angle of view” and “effective angle of view” will be defined in order to discuss the outer opening diameter OD.

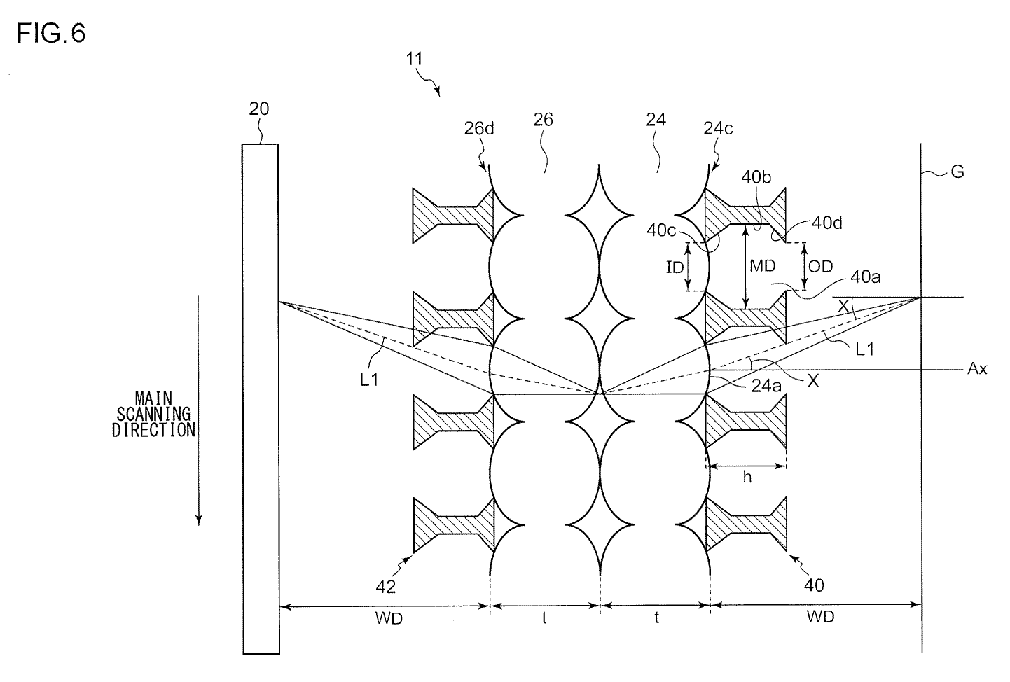

FIG. 6 is an explanatory diagram of a light-shielding wall angle of view. FIG. 6 shows the erecting equal-magnification lens array plate 11 shown in FIG. 2. FIG. 6 shows the entirety of beams from a point on the document G reaching the line image sensor 20 absent the first light-shielding wall 40 and the second light-shielding wall 42. The figure shows that only the primary beam L1 (broken line) passing through the center of the first lens 24a reaches the line image sensor 20 by providing the first light-shielding wall 40 and the second light-shielding wall 42, with an outer opening diameter OD and a height h, on the first surface 24c and the fourth surface 26d, respectively. The angle formed by the primary beam L1 and the optical axis Ax will be referred to as “light-shielding wall angle of view”. Denoting the light-shielding wall angle of view as X, the following relation given by expression (1) below holds.

tan X=0.5×OD/h (1)

It can be said that the light-shielding wall angle of view is an angle of view determined by the outer projection portion 40d.

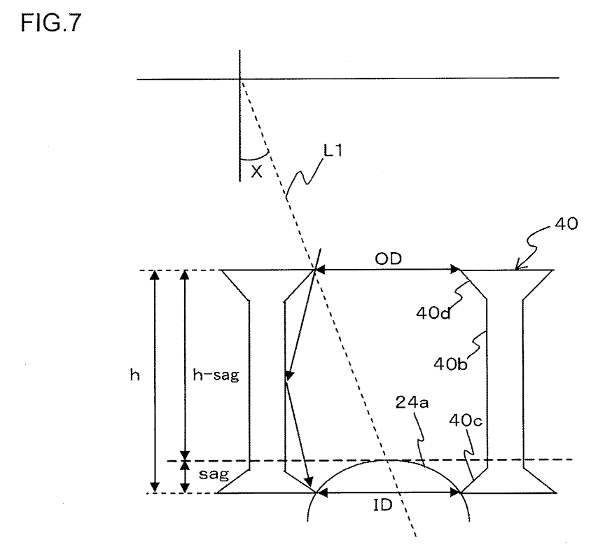

FIG. 7 is a partial enlarged view of the erecting equal-magnification lens array plate. Since the lower end surface of the inner projection portion 40c of the first light-shielding wall 40 is located more toward the first surface than the lens top as shown in FIG. 7, the height of the first light-shielding wall 40 from the top of the first lens 24a is given by h-sag, to be more precise. Therefore, h in expression (1) should be h-sag, to be more precise, so that expression (1) should be presented as expression (2) below, to be more precise.

tan X=0.5×OD/(h−sag) (2)

where sag indicates the height of the lens determined by the lens shape and the inner opening diameter ID. Since the lens shape is determined by optical design, sag is defined once the inner opening diameter ID is determined. Therefore, sag is a function of the inner opening diameter ID as a variable so that expression (2) should be presented as expression (3) below.

tan X=0.5×OD/(h−sag(ID)) (3)

Expression (3) defines the relation between the outer opening diameter OD, the height h of the first light-shielding wall 40, the inner opening diameter ID, and the light-shielding wall angle of view X.

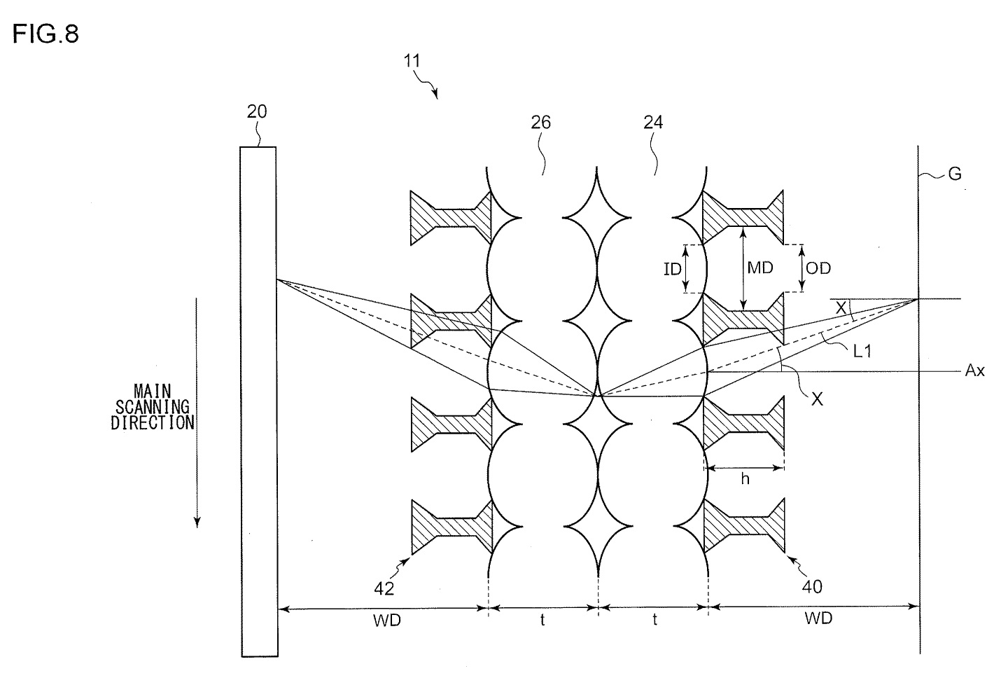

FIG. 8 shows that the primary beam L1 is asymmetrical. FIG. 6 shows that the primary beam L1 is symmetrical with respect to the interface between the first lens array plate 24 and the second lens array plate 26. In reality, however, the lens distortion affects the beam. In such a case, the primary beam L1 will be asymmetrical as shown in FIG. 8. As shown in FIG. 8, the primary beam L1 emitted from the document G is absorbed by the second light-shielding wall 42 so that no beams reach the line image sensor 20. Accordingly, the light-shielding wall angle of view X as calculated does not represent the actual angle of view. In this regard, “effective angle of view” is defined as an angle of view determined by the actual structure of the lens.

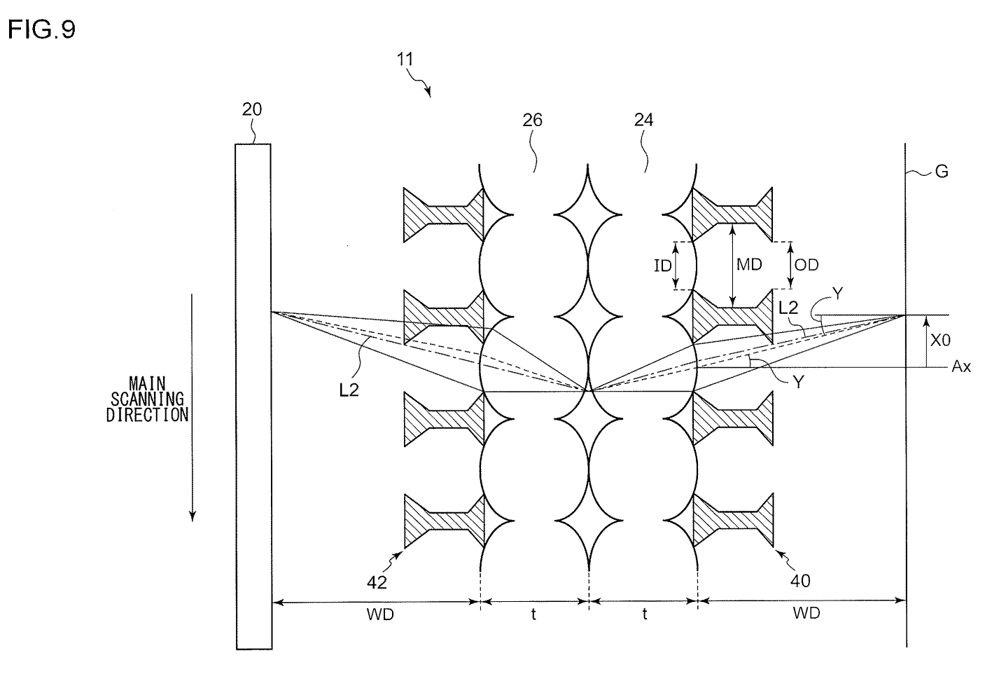

FIG. 9 is an explanatory diagram of the effective angle of view. The effective angle of view Y is given by expression (4) below and determined by measuring the distribution of the amount of light transmitted by a single lens so as to identify the viewing field radius XO that causes the amount of transmitted light to become zero.

tan Y=XO/WD (4)

FIG. 9 shows the beam L2 reaching the line image sensor 20 from the document G when the viewing field radius is XO, using a chain line. In the case shown in FIG. 9, the effective angle of view Y is smaller than the light-shielding wall angle of view X.

A description will be given of the outer opening diameter OD necessary to prevent flare noise given the light-shielding angle of view X, the effective angle of view Y, and the inner opening diameter MD of the lateral wall portion 40b. In order to ensure accurateness, a corrected effective angle of view Y′, which is derived from the effective angle of view Y, is used to define the outer opening diameter OD. The corrected effective angle of view Y′ will be described later.

In order to define the outer opening diameter OD necessary to prevent flare noise, the angle of incidence that allows beams causing flare noise to be shielded without providing the first through hole 40a with the lateral wall portion 40b, the inner projection portion 40c, and the outer projection portion 40d should be determined so as to identify a condition ensuring that the maximum angle of incidence of the beam θmax is equal to or greater than the angle of incidence as identified.

For this purpose, the principle whereby flare noise is caused will be explained, using an erecting equal-magnification lens array plate where the first through hole 40a is not provided with the lateral wall portion 40b, the inner projection portion 40c, and the outer projection portion 40d.

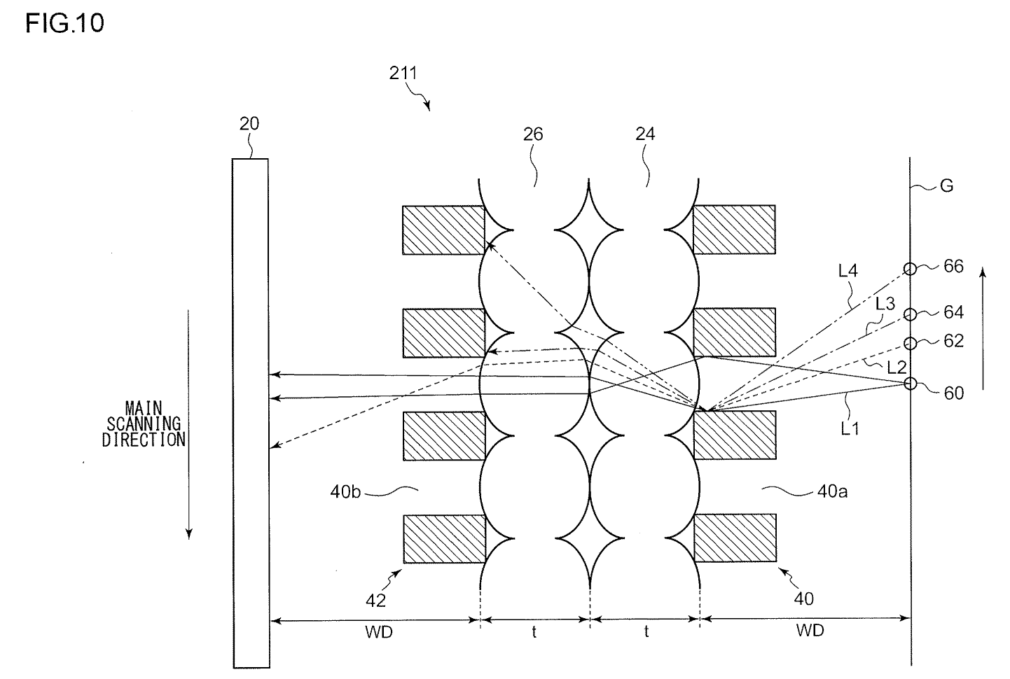

FIG. 10 is an explanatory diagram showing how flare noise is caused. The erecting equal-magnification lens array plate 211 shown in FIG. 10 is the same as the erecting equal-magnification lens array plate according to the comparative example shown in FIG. 4. In other words, the first through holes 40a of the first light-shielding wall 40 and the second through holes 42a of the second light-shielding wall 42 are simply cylindrically formed in the illustrated erecting equal-magnification lens array plate.

As explained with reference to FIG. 4, the beam L1 (solid line) emitted from the point 60 on the document G located on the optical axis of the first lens 24a is partly incident on the line image sensor 20 due to Fresnel reflection at the lateral wall of the first through hole 40a, causing flare noise. The beam L2 (broken line) emitted from the point 62 on the document G outside the optical axis of the first lens 24a is also partly incident on the line image sensor 20 due to Fresnel reflection at the lateral wall of the first through hole 40a, causing flare noise.

However, while beams L3 (chain line) and L4 (two-dot chain line) respectively emitted from points 64 and 66 further outside the optical axis than the point 62 are partly reflected by the lateral wall of the first through hole 40a due to Fresnel reflection, the reflected beam is at a certain angle with respect to the optical axis and so is absorbed by the second light-shielding wall 42 after being transmitted through the first lens array plate 24 and the second lens array plate 26. Therefore, the beams L3 and L4 do not cause flare noise.

As discussed, in the erecting equal-magnification lens array plate 211, the beam incident at an angle or greater is shielded by the second light-shielding wall 42 without providing the first through hole 40a with the inner projection portion 40c and the outer projection portion 40d.

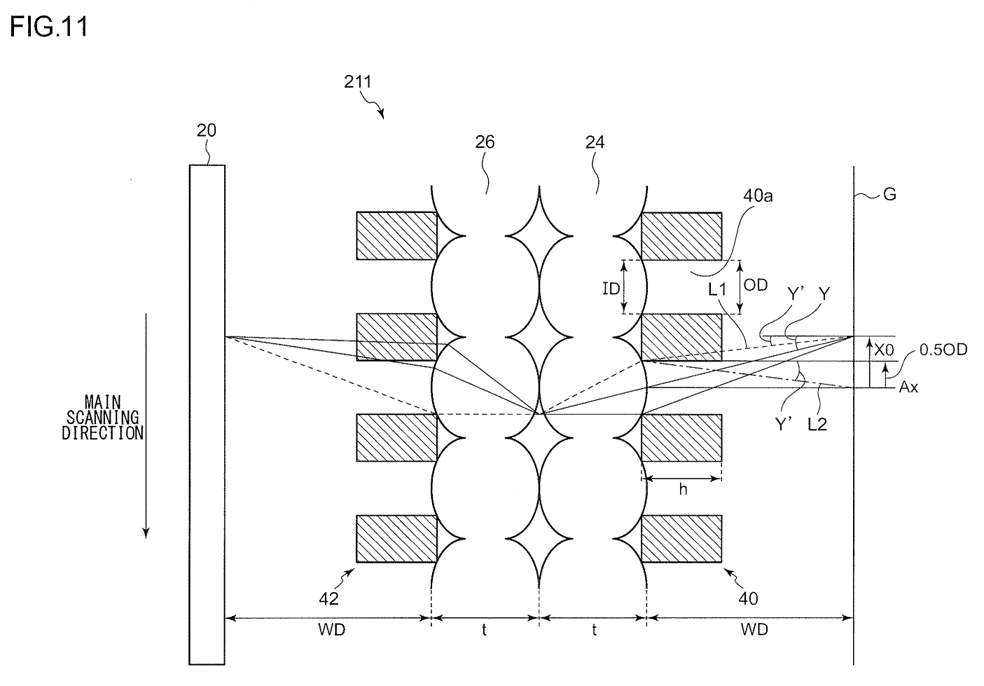

FIG. 11 is an explanatory diagram showing how the angle of incidence that allows beams to be shielded without providing the inner projection portion 40c and the outer projection portion 40d is determined. The angle of incidence can be easily determined from the effective angle of view Y. In other words, the beam at an angle of incidence equal to or greater than Y′, which is the angle of incidence of the beam L1 indicated by the broken line, will be shielded. The beam L2 indicated by the chain line and reflected by the lateral wall of the first through hole 40a causes flare noise. In other words, the beam incident at an angle close to the effective angle of view Y is shielded. In reality, the angle that ensures the shielding is the angle Y′ at which the beam reaches the open end of the first through hole 40a. The angle Y′ will be referred to “corrected effective angle of view” in the sense that the effective angle of view is corrected. The corrected effective angle of view Y′ is the angle of incidence that ensures shielding of beams causing flare noise without providing the outer projection portion 40d, etc. Referring to FIG. 11, the corrected effective angle of view is defined by expression (5) below.

tan Y′=(XO−0.5×ID)/WD (5)

It follows from the above discussion that the beam at an angle defined by tan Y′ or greater is shielded by the first light-shielding wall 40 and the second light-shielding wall 42 provided with through holes without inner projection portions or outer projection portions. Therefore, what is required will be to shield beams at an angle defined by tan Y′ or smaller by providing the inner projection portion 40c and the outer projection portion 40d.

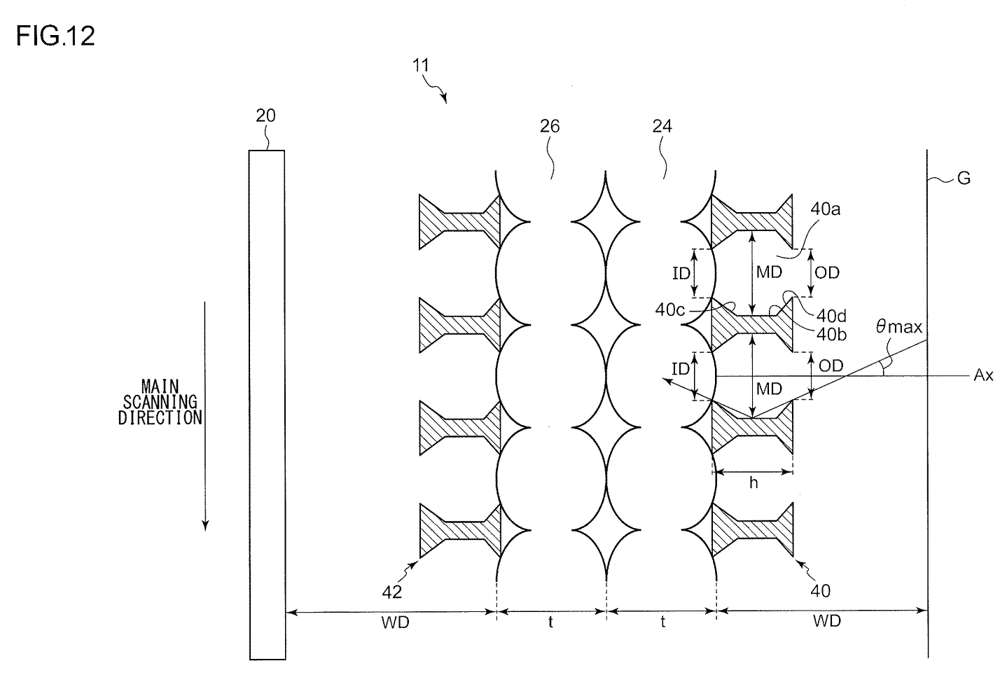

FIG. 12 is an explanatory diagram showing a condition that defines the outer opening diameter. A description will be given of a case where the inner opening diameter ID=the outer opening diameter OD. In this case, the angle of incidence of the beam reflected by the central point in the lateral wall portion 40b will be the maximum angle of incidence θmax as shown in FIG. 12. Beams with the angle of incidence equal to or smaller than the maximum angle of incidence θmax will be shielded. In this case, tan θmax will be given by expression (6) below.

tan θmax=(MD−OD)×0.5/(h×0.5)=(MD−OD)/h (6)

What is required will be that the maximum angle of incidence θmax is greater than the angle of incidence that ensures shielding of beams causing flare noise without providing the outer projection portion 40d, etc. Therefore, the relation defined by expression (7) below holds.

(MD−OD)/h≧tan Y′ (7)

The relation defined by expression (3) above holds in order to maintain the angle of view of the lens constant. The condition for removing flare is defined by expressions (3) and (7). Since it is given that the inner opening diameter ID=the outer opening diameter OD, expression (3) may use one less variable and is presented as expression (8) below.

tan X=0.5×OD/(h−sag(OD)) (8)

Since expression (8) contains the function sag(OD), expressions (7) and (8) cannot be resolved analytically and should be resolved by numerical computation. More specifically, values of OD and h that satisfy the condition defined by expression (7) may be identified by computing values of OD and h that satisfy expression (8) and substituting the identified values of OD and h into expression (7).

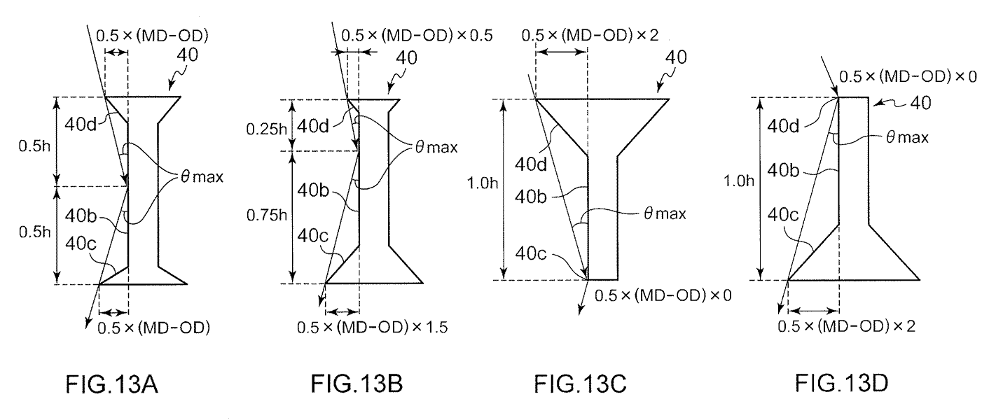

FIGS. 13A-13D are explanatory diagrams showing conditions that define the outer diameter OD in the case that the inner opening diameter ID≠the outer opening diameter OD. The description regarding the case where the inner opening diameter ID=the outer opening diameter OD will be repeated here. As shown in FIG. 13A, the size of the outer projection portion 40d from the lateral wall portion 40b of the inner diameter MD is given by 0.5×(MD−OD). The size of the inner projection portion 40c from the lateral wall portion 40b is also given by 0.5×(MD−OD). Accordingly, the beam with the maximum angle of incidence θmax is reflected at the position where the height is half the height h of the light-shielding wall.

Subsequently, a discussion will be given of the condition ensuring that the maximum angle of incidence θmax is the same as the angle shown in FIG. 13A in the case that the inner opening diameter ID≠the outer opening diameter OD. FIG. 13B shows a case where the amount of projection of the outer projection portion 40d relative to the lateral wall portion 40b is half the amount shown in FIG. 13A. In this case, the beam should be incident at the position where the height is 0.25×h in order to ensure that the maximum angle of incidence θmax is the same as the angle shown in FIG. 13A. In this case, the reflected beam travels the height of the light-shielding wall given by 0.75×h, which is 1.5 times the height traveled in the case of FIG. 13A, before reaching the mouth of the inner opening. Therefore, the amount of projection of the inner projection portion 40c from the lateral wall portion 40b should be 1.5 times as large. Thus, when the amount of projection of the outer projection portion 40d relative to the lateral wall portion 40b is reduced to half, the maximum angle of incidence θmax is secured if the inner projection portion 40c is extended by a commensurate amount.

Both in FIGS. 13A and 13B, the sum of the amount of projection of the outer projection portion 40d from the lateral wall 40b and the mount of projection of the inner projection portion 40c from the lateral wall portion 40b is given by MD−OD. This means that the maximum angle of incidence θmax is secured even when only the outer projection portion 40d or only the inner projection portion 40c is designed to project by the amount MD−OD as shown in FIGS. 13C and 13D. Thus, the maximum angle of incidence is determined when the sum of the amount of projections relative to the lateral wall portion 40b is determined in the case that the inner opening diameter ID≠the outer opening diameter OD.

Expression (6) in the case that the inner opening diameter ID≠the outer opening diameter OD will be expression (9) below.

tan θmax=((MD−OD)×0.5+(MD−ID)×0.5)/h=(MD−(OD+ID)×0.5)/h (9).

Therefore, expression (10) below will replace the corresponding expression (7). Expression (10) is derived from replacing OD in expression (7) by (OD+ID)×0.5.

(MD−(OD+ID)×0.5)/h≧tan Y′ (10)

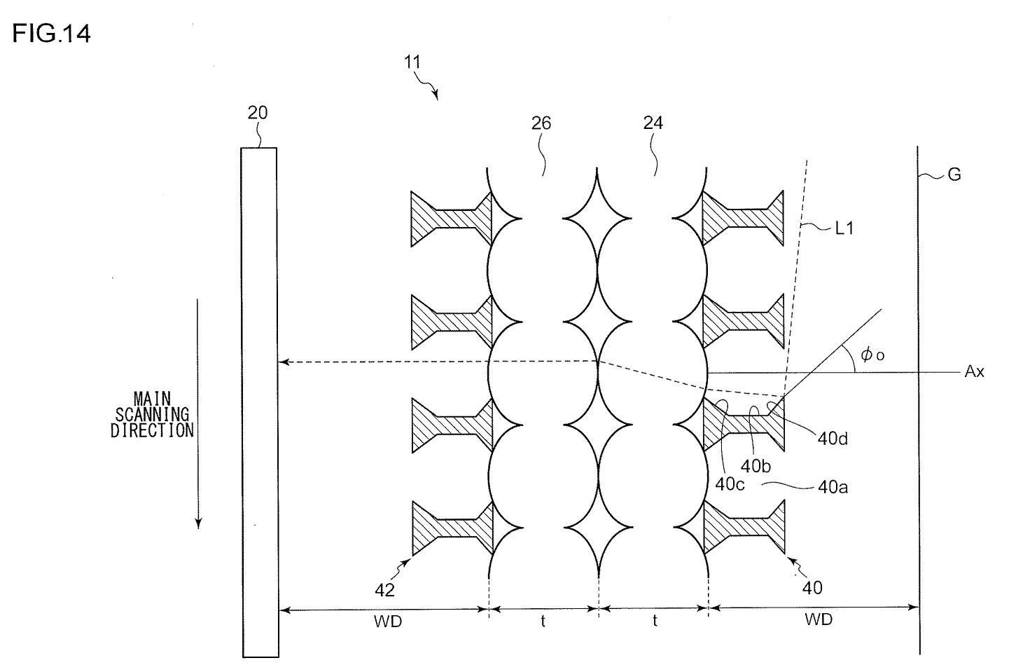

FIG. 14 is an explanatory diagram showing an angle of inclination φo of the tapered surface formed in the outer projection portion 40d. If the tapered surface is not formed (e.g., when a surface parallel to the optical axis Ax is formed in the outer projection portion 40d), the light reflected by the surface parallel to the optical axis Ax may cause flare noise.

In the erecting equal-magnification lens array plate 11 according to this embodiment, the outer projection portion 40d is provided with a tapered surface inclined with respect to the optical axis Ax. Therefore, flare noise is more successfully reduced as compared with the case where there is a surface parallel to the optical axis Ax. An optimum angle of inclination φo of the tapered surface will be discussed. Preferably, the angle of inclination φo of the tapered surface be 45° or greater. In the case that the angle of inclination φo is 45°, the beam should be substantially perpendicular to the optical axis Ax, as indicated by the beam L1 (broken line) of FIG. 14, in order for the beam reflected once to reach the image sensor 20. Since there should be virtually no such beams as the beam L1, it is substantially impossible for the beam reflected by the tapered surface of the outer projection portion 40d to cause flare noise. Further, considering the fact that the beam from a range of angle of incidence of about several (e.g., 3) degrees would not produce adverse effects, the size of the line image sensor 20 is limited in practice so that the angle of inclination φo of the tapered surface may be as small as 40°-42° in order to be substantively effective to reduce flare noise. Meanwhile, while the angle of inclination φo of the tapered surface need only be 40° or greater, or 45° or greater theoretically, it is further preferable to allow for a margin of about 10° beyond 45° and make the angle 55° or greater, considering the effects from errors produced during the manufacture.

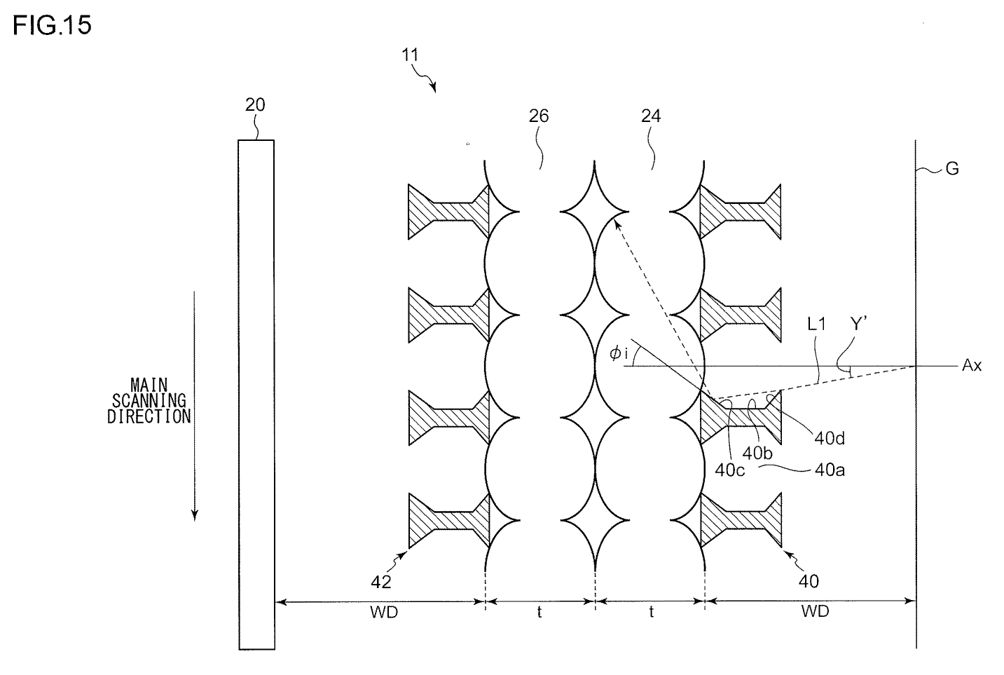

FIG. 15 is an explanatory diagram showing an angle of inclination φi of the tapered surface formed in the inner projection portion 40c. If the tapered surface is not formed (e.g., when a surface parallel to the optical axis Ax is formed in the inner projection portion 40c), the light reflected by the surface parallel to the optical axis Ax may cause flare noise.

The angle of incidence (corrected effective angle of view Y′) that prevents flare noise without providing the first through hole 40a with the inner projection portion 40c and the outer projection portion 40d was described with reference to FIG. 11. The angle of inclination φi of the tapered surface should be defined such that the beam L1 (broken line) incident at the angle Y′ travels substantially perpendicular to the optical axis Ax after being reflected by the inner projection portion 40c. Therefore, the angle of inclination φi of the tapered surface of the inner projection portion 40c should preferably be equal to or greater than half the corrected effective angle of view Y′ with respect to the optical axis Ax. In this case, the beam L1 reflected by the tapered surface of the inner projection portion 40c travels substantially perpendicular to the optical axis Ax so that flare noise is prevented.

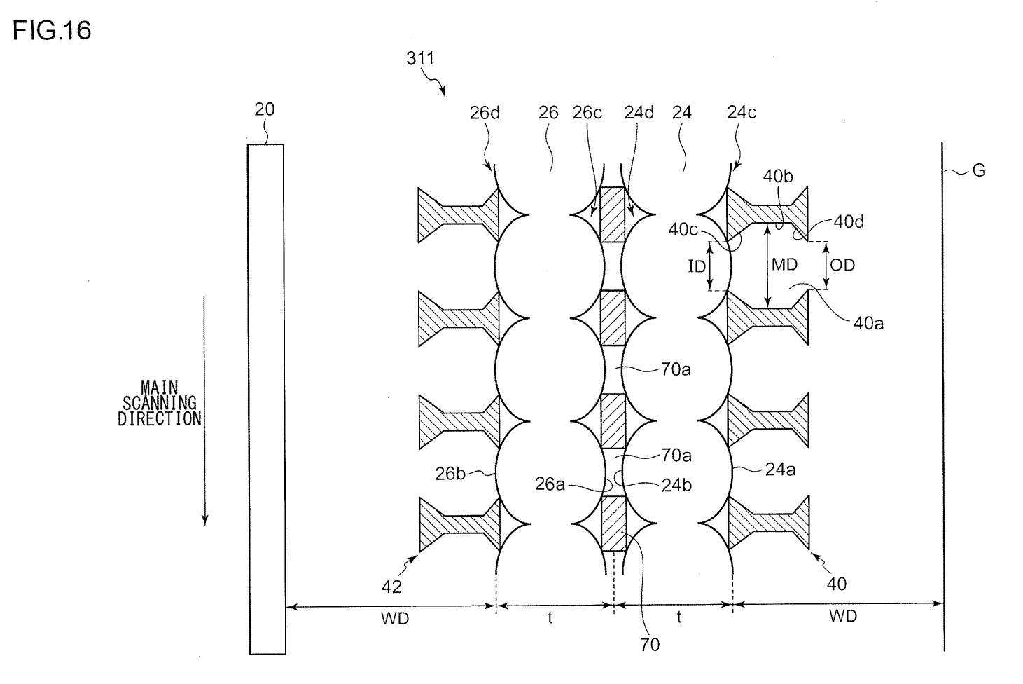

FIG. 16 is an explanatory diagram showing an erecting equal-magnification lens array plate 311 according to another embodiment of the present invention. The erecting equal-magnification lens array plate 311 shown in FIG. 16 differs from the erecting equal-magnification lens array plate 11 shown in FIG. 2 in that an intermediate light-shielding member 70 is provided between the second surface 24d of the first lens array plate 24 and the third surface 26c of the second lens array plate 26. The other components are similar to those of the erecting equal-magnification lens array plate 11 shown in FIG. 2 so that like numerals represent like elements and the description is omitted as appropriate.

The intermediate light-shielding member 70 is a light-shielding member of a plate shape formed by, for example, injection molding using a light absorbing material such as black ABS resin. The intermediate light-shielding member 70 is provided with a plurality of third through holes 70a formed to be in alignment with the second lenses 24b of the first lens array plate 24 and the third lenses 26a of the second lens array plate 26. The intermediate light-shielding member 70 is provided between the first lens array plate 24 and the second lens array plate 26 such that each third through hole 70a is located opposite to the corresponding second lens 24b and the corresponding third lens 26a.

In the erecting equal-magnification lens array plate 11 shown in FIG. 2, the light reflected by the interior wall of the first through hole 40a of the first light-shielding wall 40 does not reach the line image sensor 20 and does not cause flare noise. However, the light reflected by the interior wall of the first through hole 40a might leak to the line image sensor 20 due to lens distortion or errors in assembling the lens array plate and the light-shielding member. By providing the intermediate light-shielding member 70, the light is prevented from leaking to the line image sensor 20 so that flare noise is more suitably reduced. The inner diameter of the third through hole 70a should preferably be equal to or greater than the outer opening diameter OD so that the imaging light is not shielded.

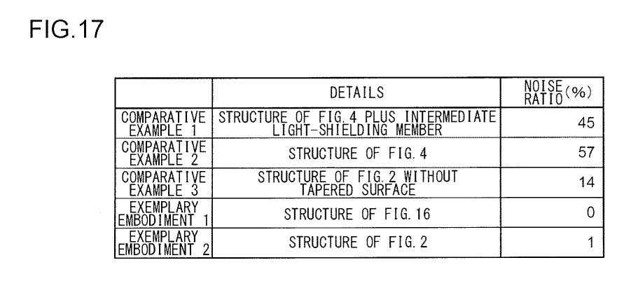

FIG. 17 shows how the noise ratio varies as the structure of the erecting equal-magnification lens array plate is varied. A ray tracing simulation was conducted. The entirety of the erecting equal-magnification lens array plate is illuminated in the main scanning direction by a 90° Lambertian emission from a point light source. The amount of imaging light arriving at a specified point on the image plane is designated as the amount of imaging light transmitted. The amount of light arriving elsewhere is designated as the amount of light transmitted as noise. The illumination and measurement are conducted on a line extending in the main scanning direction. A noise ratio is defined as a sum of the amount of light transmitted as noise divided by the amount of imaging light transmitted.

The conditions of simulation are such that the lenses are arranged in a single line, the lens's working distance WD=3.3 mm, the plate thickness t of the first and second lens array plates is such that t=1.6 mm, the lens pitch=0.65 mm, the lens diameter=0.65 mm, the refractive index n=1.53, the height h of the first and second light-shielding walls is such that h=0.66 mm, the inner opening diameter ID=0.47 mm, the outer opening diameter OD=0.47 mm, the inner diameter D of the through hole according to the comparative example is such that D=0.47 mm, the inner diameter MD of the lateral wall portion according to the exemplary embodiment is such that MD=0.6 mm, the angle of inclination φi of the tapered surface of the inner projection portion is such that φi=45°, the angle of inclination φo of the tapered surface of the outer projection portion is such that φo=45°, and the inner diameter of the third through hole in the intermediate light-shielding member=0.5 mm. The sag is 0.07 mm when the inner opening diameter ID=0.47 mm. The simulation conducted in this optical system determines the viewing radius XO to be 0.91 mm. Using expression (5), tan Y′ is determined to be 0.202. Meanwhile, (MD−OD)/h on the left side of expression (7) is 0.203. Since 0.203≧0.202, the lens is an optical system that satisfies expression (7).

Using the above condition, the noise ratio is calculated in comparative examples 1-3 and first and second exemplary embodiments. The comparative example 1 models the structure in which the intermediate light-shielding member is added between the first lens array plate 24 and the second lens array plate 26 of the erecting equal-magnification lens array plate 211 shown in FIG. 4. The comparative example 2 models the erecting equal-magnification lens array plate 211 shown in FIG. 4. The comparative example 3 models the structure in which the tapered surface of the inner projection portion 40c and the outer projection portion 40d in the erecting equal-magnification lens array plate 11 shown in FIG. 2 is eliminated so that surfaces parallel to the optical axis are formed. The exemplary embodiment 1 models the erecting equal-magnification lens array plate 311 shown in FIG. 16. The exemplary embodiment 2 models the erecting equal-magnification lens array plate 11 shown in FIG. 2.

As shown in FIG. 17, the noise ratios in the comparative examples 1 and 2 are 45% and 57%, respectively, which are relatively high. The noise ratio is reduced to 14% in the comparative example 3 by forming the inner projection portion and the outer projection portion in the through holes. However, some noise is produced since the surface parallel to the optical axis is formed in the inner projection portion and the outer projection portion.

Meanwhile, the exemplary embodiments 1 and 2 of the present invention achieve considerably low noise ratios of 0% and 1%, respectively. The noise ratios do not differ so much between the first and second exemplary embodiments, which differ in terms of whether the intermediate light-shielding member is provided or not. This shows that the structure of the second exemplary embodiment, which is not provided with the intermediate light-shielding member, is sufficiently practical. The simulation demonstrates that the erecting equal-magnification lens array plate according to the embodiment of the present invention is useful to reduce noise.

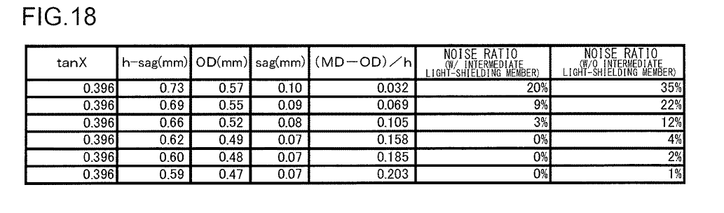

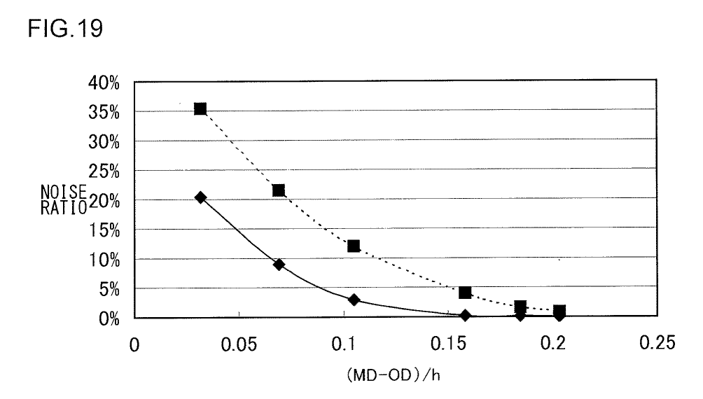

Variation in the amount of noise when (MD−OD)/h on the left side of expression (7) is varied was then examined. FIG. 18 shows the result of simulation performed by maintaining the condition in which tan X in expression (3) remains constant, while the outer opening diameter OD and the height h of the first and second light-shielding walls are varied. Under each of these conditions, the noise ratio is determined for a case where the intermediate light-shielding member is provided and for a case where it is not. FIG. 19 shows the relation between (MD−OD)/h on the left side of expression (7) and the noise ratio. Referring to FIG. 19, the solid line indicates the relation between (MD−OD)/h and the noise ratio occurring when the intermediate light-shielding member is provided, and the broken line indicates the relation between (MD−OD)/h and the noise ratio occurring when the intermediate light-shielding member is not provided.

As shown in FIGS. 18 and 19, under the condition in which the intermediate light-shielding member is not provided, the noise is increased progressively as (MO−OD)/h drops below tan Y′. Under the condition in which the intermediate light-shielding member is provided, the noise is not produced until (MD−OD)/h=0.158. Therefore, since tan Y′=0.202, tan Y′ on the right side of expressions (7) and (10) may be lowered to tan Y′×0.78 and still the flare noise is effectively reduced (0.158/0.202=0.78). Expressions (11) and (12), obtained by replacing the right side of expressions (7) and (10), respectively, by tan Y′×0.78, are given below.

(MD−OD)/h≧tan Y′×0.78 (11)

(MD−(OD+ID)×0.5)/h≧tan Y′×0.78 (12)

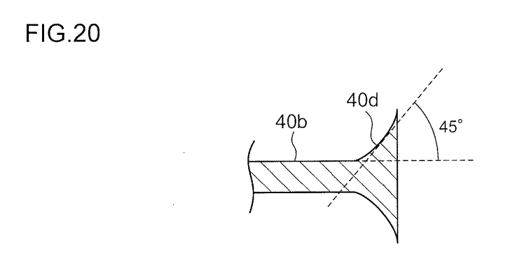

FIG. 20 shows a variation of the outer projection portion 40d. In the embodiments described above, an inclined surface of a tapered shape is formed in the outer projection portion 40d. However, the angle of inclination need not be uniform. For example, the inclined surface may be a curved surface having a tangent line with the minimum angle of 45°.

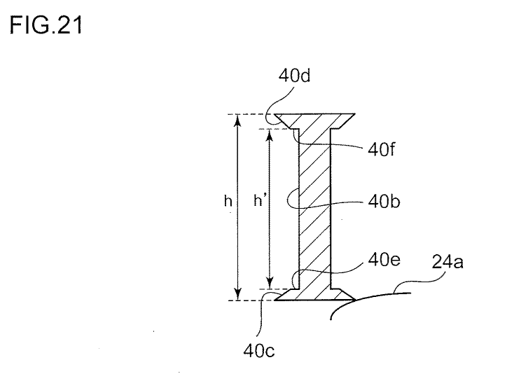

FIG. 21 shows variations of the inner projection portion 40c and the outer projection portion 40d. As shown in FIG. 21, the inner projection portion 40c and/or the outer projection portion 40d may be formed with surfaces 40e and 40f, respectively, perpendicular to the optical axis.

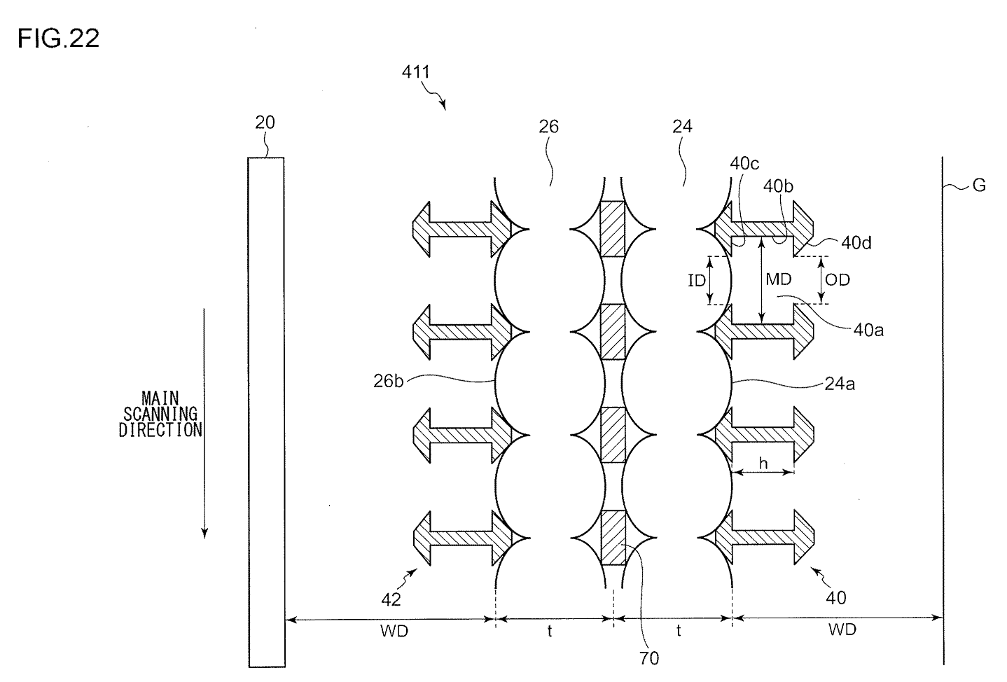

FIG. 22 is an explanatory diagram showing an erecting equal-magnification lens array plate 411 according to still another embodiment of the present invention. In the erecting equal-magnification lens array plate 411 shown in FIG. 22, the shapes of the inner projection portion and the outer projection portion in the first and second light-shielding walls 40 and 42 are different from those of the erecting equal-magnification lens array plate 311 shown in FIG. 16. Since the first light-shielding wall 40 and the second light-shielding wall 42 have the identical shape, the first light-shielding wall 40 will be described below by way of example.

The tapered surface of the first light-shielding wall 40 and the second light-shielding wall 42 according to the embodiment described above is located within the height h of the first light-shielding wall 40. In contrast, the tapered surface of the first light-shielding wall 40 and the second light-shielding wall 42 according to this embodiment is located outside the height h. The tapered surface according to this embodiment is formed such that inner diameter grows larger toward the outer end of the first through hole 40a in the direction of height. The tapered surface such as this will be referred to as “inverse tapered surface” in this specification. Surfaces parallel to the optical axis are prevented from being formed by forming inverse tapered surfaces. Therefore, flare noise is reduced.

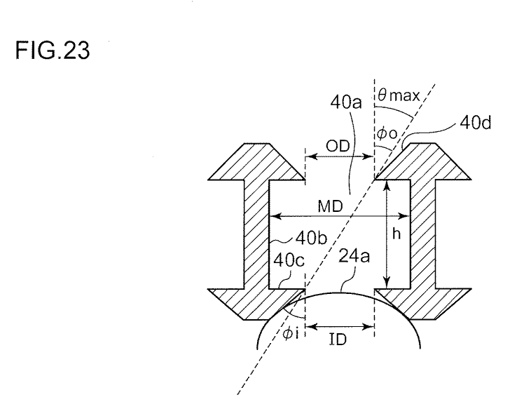

FIG. 23 is an explanatory diagram showing the angle of inclination φo of the inverse tapered surface of the first light-shielding wall with respect to the optical axis. As shown in FIG. 23, the angle of inclination φo should preferably be set at the maximum angle of incidence φmax or greater. By ensuring that the angle of inclination φo of the inverse tapered surface to be equal to or greater than the maximum angle of incidence φmax, the light reflected by the inverse tapered surface of the outer projection portion 40d is prevented from entering the first lens 24a. The angle of inclination larger than the maximum angle of incidence also ensures that the beam does not reach the tapered surface of the inner projection portion 40c. Therefore, flare noise is suitably reduced.

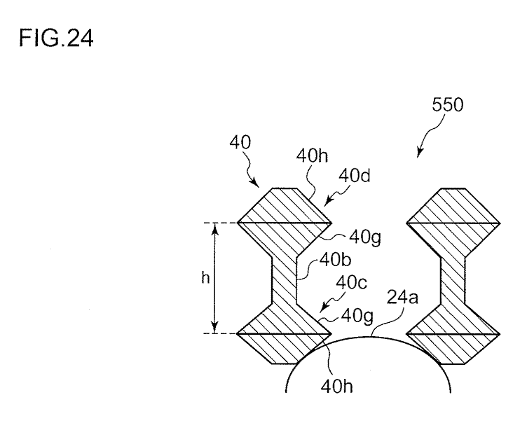

FIG. 24 is an explanatory diagram showing an erecting equal-magnification lens array plate 550 according to still another embodiment of the present invention. FIG. 24 shows a part of the erecting equal-magnification lens array plate 550. As shown in FIG. 24, in addition to a tapered surface 40g located within the height h of the first light-shielding wall 40, the inner projection portion 40c and the outer projection portion 40d are formed with inverse tapered surfaces 40h located outside the height h of the first light-shielding wall 40. The erecting equal-magnification lens array plate 550 according to this embodiment also reduces flare noise suitably.

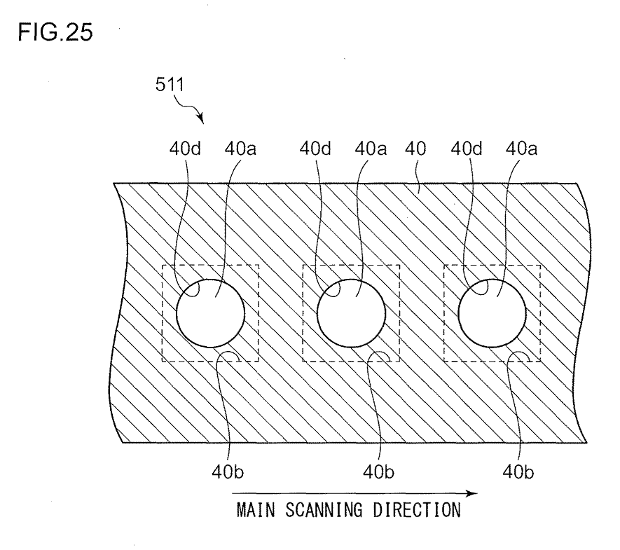

FIG. 25 is an explanatory diagram showing an erecting equal-magnification lens array plate 511 according to still another embodiment of the present invention. Like FIG. 3, FIG. 25 is a top view of a part of the erecting equal-magnification lens array plate 511 viewed from a document. The shape of the lateral wall portion 40b of the first through hole 40a in the erecting equal-magnification lens array plate 511 according to this embodiment differs from that of the erecting equal-magnification lens array plate 11 shown in FIG. 3. In the erecting equal-magnification lens array plate 511 according to this embodiment, the lateral wall portion 40b is formed as a square pole. The openings formed by the outer projection portion 40d and the inner projection portion 40c are circularly shaped.

The outer projection portion 40d and the inner projection portion 40c should preferably have the maximum size permitted by the space in order to remove flare noise suitably. By forming the lateral wall portion 40b as a square pole, the outer projection portion 40d and the inner projection portion 40c can be formed larger. In this way, flare noise is reduced more successfully.

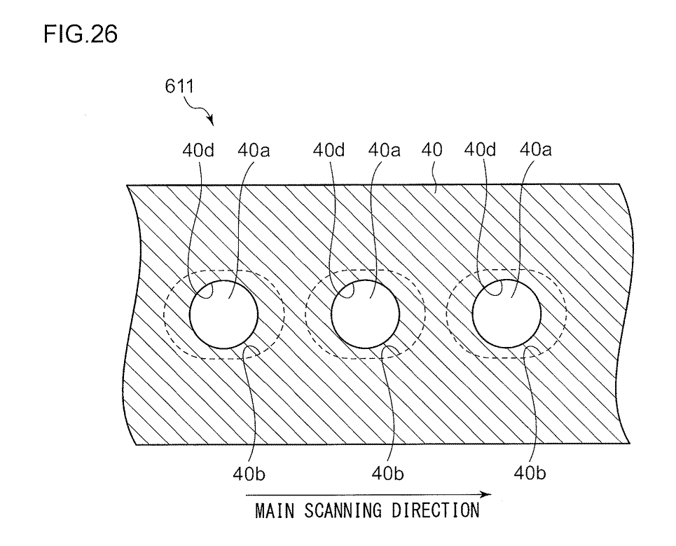

FIG. 26 is an explanatory diagram showing an erecting equal-magnification lens array plate 611 according to still another embodiment of the present invention. FIG. 26 is also a top view of a part of the erecting equal-magnification lens array plate 611 viewed from a document. In the erecting equal-magnification lens array plate 611 according to this embodiment, the lateral portion 40b of the first through hole 40a is formed in the shape of an oval coin in a plan view. The openings formed by the outer projection portion 40d and the inner projection portion 40c are in a circular shape. In this case, too, the outer projection portion 40d and the inner projection portion 40c can be formed larger than when the hole is formed in a cylindrical shape as shown in FIG. 3.

Described above is an explanation based on an exemplary embodiment. The embodiment is intended to be illustrative only and it will be obvious to those skilled in the art that various modifications to constituting elements and processes could be developed and that such modifications are also within the scope of the present invention.

In the embodiment described, lenses on the respective lens surfaces are arranged in a single row in the main scanning direction. Alternatively, lenses may be arranged in two rows in the main scanning direction or arranged in a square array.

In the erecting equal-magnification lens array plates described above, the inner diameter MD of the first through hole and the second through hole is uniform in the direction of height of the through hole. Alternatively, the inner diameter MD may not be uniform. The inner diameter MD may vary linearly or nonlinearly. Still alternatively, the inner diameter MD may be progressively larger away from the lens.

In the embodiments described above, the inner projection portion and the outer projection portion are provided in both the first light-shielding wall and the second light-shielding wall. However, flare noise is effectively reduced so long as the inner projection portion and the outer projection portion are provided in one of the first light-shielding wall and the second light-shielding wall. Further, flare noise is effectively reduced by providing one of the inner projection portion and the outer projection portion in the through hole.

What is claimed is:

1. An erecting equal-magnification lens array plate comprising:
a first lens array plate provided with a plurality of first lenses systematically arranged on a first surface and a plurality of second lenses systematically arranged on a second surface opposite to the first surface;
a second lens array plate provided with a plurality of third lenses systematically arranged on a third surface and a plurality of fourth lenses systematically arranged on a fourth surface opposite to the third surface;
a first light-shielding wall having a plurality of first through holes aligned with the first lenses, and provided on the first surface such that each of the first through holes is located opposite to the corresponding first lens; and
a second light-shielding wall having a plurality of second through holes aligned with the fourth lenses, and provided on the fourth surface such that each of the second through holes is located opposite to the corresponding fourth lens;
wherein the first lens array plate and the second lens array plate form a stack such that the second surface and the third surface face each other to ensure that a combination of the lenses aligned with each other form a coaxial lens system, the erecting equal-magnification lens array plate receiving light from a line light source facing the first surface and forming an erect equal-magnification image of the line light source on an image plane facing the fourth surface, and
wherein each of the first through holes or each of the second through holes, or each of the first and second through holes, comprises:
a lateral wall portion;
an annular inner projection portion provided to project from an end of the lateral wall portion facing the lens; and
an annular outer projection portion provided to project from an end of the lateral wall portion opposite to the end facing the lens,
wherein the inner projection portion and the outer projection portion are not formed with a surface parallel to an optical axis.

2. The erecting equal-magnification lens array plate according to claim 1,
wherein the outer projection portion is formed with a surface inclined at 45° or greater with respect to the optical axis.

3. The erecting equal-magnification lens array plate according to claim 1,
wherein the inner projection portion is formed with a surface inclined by an angle equal to or greater than half a corrected effective angle of view with respect to the optical axis.

4. The erecting equal-magnification lens array plate according to claim 1,
wherein the inner projection portion and the outer projection portion are formed such that the portions have the identical height.

5. The erecting equal-magnification lens array plate according to claim 1, configured such that
tan X=0.5×OD/(h−sag(ID)) and
(MD−(OD+ID)×0.5)/h≧tan Y′,
where X denotes a light-shielding wall angle of view, Y′ denotes a corrected effective angle of view, MD denotes an inner diameter of the lateral wall portion, OD denotes a diameter of an opening formed inside the outer projection portion, ID denotes a diameter of an opening formed inside the inner projection portion, sag denotes a lens height determined by ID and a lens shape.

6. The erecting equal-magnification lens array plate according to claim 1, further comprising an intermediate light-shielding member having a plurality of third through holes aligned with the second lenses and the third lenses,
wherein the intermediate light-shielding member is provided between the first lens array plate and the second lens array plate such that the third through holes are located opposite to the corresponding second lenses and the corresponding third lenses.

7. The erecting equal-magnification lens array plate according to claim 1, configured such that
tan X=0.5×OD/(h−sag(ID)) and
(MD−(OD+ID)×0.5)/h≧tan Y′×0.78,
where X denotes a light-shielding wall angle of view, Y′ denotes a corrected effective angle of view, MD denotes an inner diameter of the lateral wall portion, OD denotes a diameter of an opening formed inside the outer projection portion, ID denotes a diameter of an opening formed inside the inner projection portion, sag denotes a lens height determined by ID and a lens shape.

8. An optical scanning unit comprising:
a line light source configured to illuminate an image to be read;
the erecting equal-magnification lens array plate according to claim 1 configured to condense light reflected by the image to be read; and
a line image sensor configured to receive light transmitted by the erecting equal-magnification lens array plate.

9. An image reading device comprising:
the optical scanning unit according to claim 8; and
an image processing unit configured to process an image signal detected by the optical scanning unit.

10. An erecting equal-magnification lens array plate comprising:
a first lens array plate provided with a plurality of first lenses systematically arranged on a first surface and a plurality of second lenses systematically arranged on a second surface opposite to the first surface;
a second lens array plate provided with a plurality of third lenses systematically arranged on a third surface and a plurality of fourth lenses systematically arranged on a fourth surface opposite to the third surface,
a first light-shielding wall having a plurality of first through holes aligned with the first lenses, and provided on the first surface such that each of the first through holes is located opposite to the corresponding first lens; and
a second light-shielding wall having a plurality of first through holes aligned with the fourth lenses, and provided on the fourth surface such that each of the second through holes is located opposite to the corresponding fourth lens;
wherein the first lens array plate and the second lens array plate form a stack such that the second surface and the third surface face each other to ensure that a combination of the lenses aligned with each other form a coaxial lens system, the erecting equal-magnification lens array plate receiving light from a line light source facing the first surface and forming an erect equal-magnification image of the line light source on an image plane facing the fourth surface, and
wherein at least one of the first through hole and the second through hole comprises:
a lateral wall portion;
an annular inner projection portion provided to project from an end of the lateral wall portion facing the lens, or an annular outer projection portion provided to project from an end of the lateral wall portion opposite to the end facing the lens,
wherein the inner projection portion or the outer projection portion is not formed with a surface parallel to an optical axis.

11. The erecting equal-magnification lens array plate according to claim 10,
wherein the outer projection portion is formed with a surface inclined at 45° or greater with respect to the optical axis, or the inner projection portion is formed with a surface inclined by an angle equal to or greater than half a corrected effective angle of view with respect to the optical axis.

12. The erecting equal-magnification lens array plate according to claim 10, further comprising an intermediate light-shielding member having a plurality of third through holes aligned with the second lenses and the third lenses, wherein the intermediate light-shielding member is provided between the first lens array plate and the second lens array plate such that the third through holes are located opposite to the corresponding second lenses and the corresponding third lenses.

13. An optical scanning unit comprising:
a line light source configured to illuminate an image to be read;
the erecting equal-magnification lens array plate according to claim 10 configured to condense light reflected by the image to be read; and
a line image sensor configured to receive light transmitted by the erecting equal-magnification lens array plate.

14. An image reading device comprising:
the optical scanning unit according to claim 13; and an image processing unit configured to process an image signal detected by the optical scanning unit.
